(19) United States
(12) Patent Application Publication
(10) Pub. No.: US 2007/0166663 A1
(43) Pub. Date: Jul. 19, 2007

(54) CORDLESS ULTRASONIC DENTAL SCALER

(76) Inventors: Heidi A. Telles, Avon, CO (US); Tracey Newborn, Breckenridge, CO (US)

Correspondence Address: MARK YOUNG, P.A., 12086 FORT CAROLINE ROAD, UNIT 202, JACKSONVILLE, FL, 32225, US

(21) Appl. No.: 11/624,675

(22) Filed: Jan. 18, 2007

Related U.S. Application Data
(60) Provisional application No. 60/766,428, filed on Jan. 18, 2006.

(51) Int. Cl. A61C 3/03

(52) U.S. Cl. 433/119

(57) ABSTRACT

A cordless ultrasonic scaler includes a cleaning tip, an actuator, power supply, control circuitry, a water reservoir and a pumping mechanism within the hand piece. A piezoelectric stack actuator drives both the cleaning tip and pumping mechanism. The reservoir in the hand piece supplies liquid to the pump for cooling the actuator, the cleaning tip and the teeth being cleaned. The reservoir defines a battery compartment. A pair of electrodes enable recharging the battery in a docking station when the device is not in use. Controls are provided for the actuator and fluid flow.

### RELATED APPLICATION

This application claims the benefit of priority of U.S. provisional application 60/766,428, filed Jan. 18, 2006, the entire contents of which are incorporated herein by this reference.

### FIELD OF THE INVENTION

This invention relates to dental tools, and more particularly, to a cordless ultrasonic dental scaler with a vibrating tip, an internal water supply and a pumping mechanism.

### BACKGROUND

Ultrasonic dental scalers are among the various tools used by dentists for scraping plaque and bacterial debris from teeth. Conventional ultrasonic dental scalers vibrate a cleaning tip connected to a hand piece at a high frequency to remove plaque from teeth. Typically, an alternating current induces vibration of a magnetostrictive transducer element in the hand piece to drive the cleaning tip. Because of the high rate of tip vibration, the high-speed ultrasonic transducer generates a significant amount of heat. Accordingly, ultrasonic scalers typically operate with a water jet in the tip. While the ultrasonic scaler operates, the water cools the tip, the tooth being treated and the transducer element.

Although such ultrasonic scalers are effective for cleaning teeth, they are cumbersome to operate because they have cords and tubing which add appreciable weight and can be difficult to manipulate during a procedure. Control circuitry for the transducer is typically located in a control module that is separate from and wired to the hand piece. Utility electric power is supplied to the control circuitry via a conventional plug and wiring. Water is provided to the unit via tubing and a fluid coupling. The wiring and tubing to the hand piece are typically bundled and contained in a sheath, so that a single sheathed conduit connects the hand piece to the control module. During use, considerable care must be exercised to avoid entangling the conduit and occluding or damaging the tubing contained therein. Additionally, during the entire procedure, the operator must continually support the hand piece as well as the conduit, including the water flowing within the tubing.

A cordless ultrasonic dental scaler is needed. The cordless ultrasonic scaler should contain an actuator, power supply, control circuitry, a water reservoir and a pumping mechanism within the hand piece.

The invention is directed to overcoming one or more of the problems as set forth above.

### SUMMARY OF THE INVENTION

To overcome problems as set forth above, a cordless ultrasonic scaler is provided. The cordless ultrasonic scaler includes an actuator, power supply, control circuitry, a water reservoir and a pumping mechanism within a hand piece. A piezoelectric stack actuator drives both the cleaning tip and pumping mechanism. The reservoir in the hand piece supplies liquid to the pump for cooling the actuator, the cleaning tip and the teeth being cleaned. The reservoir defines a battery compartment. A pair of electrodes enable recharging the battery in a charging base when the device is not in use. Controls are provided for the actuator and fluid flow.

In another aspect of the invention, an exemplary cordless ultrasonic dental scaler includes a scaler tip which is preferably releasably attached and has a conduit for passage of a liquid, such as water. A hand piece houses an actuator coupled to the scaler tip. A linkage couples the scaler tip to the actuator. A portable rechargeable power supply is contained within the hand piece. A control circuit is electrically connected to the power supply and to the actuator. The control circuit is configured to energize the actuator. A liquid reservoir is also provided in the hand piece. A pumping mechanism in fluid communication with the liquid reservoir and the scaler tip is adapted to pump liquid from the liquid reservoir to scaler tip. The control circuit is configured to produce a voltage waveform and the actuator is configured to receive the voltage waveform and vibrate in response thereto. The linkage transmits vibration of the actuator to the scaler tip. The actuator may be a piezoelectric actuator, such as a piezoelectric electric stack comprising a plurality of electro-active ceramic elements responsive to the voltage waveform. Alternatively, a transducer or motor may serve as the actuator. A heat sink may be thermally coupled to the actuator to dissipate heat. The heat sink may include a liquid conduit in fluid communication between the liquid reservoir and scaler tip. The conduit enables liquid from the reservoir to flow through the conduit and cool the actuator. The conduit in the scaler tip preferably terminates with an atomizing nozzle configured to atomize liquid expelled therefrom. The control circuitry includes a piezo voltage driver adapted to controllably energize the actuator, the actuator is a piezoelectric actuator. If the piezoelectric actuator is adapted to generate feedback signals, the control circuitry may further include a microcontroller adapted to receive and monitor feedback signals from the piezoelectric actuator to adjust the voltage waveform. A light source may be provided to illuminate the scaler tip. The light source may include an LED within the hand piece and a fiber optic filament configured to transmit light from the LED to the scaler tip. The pumping mechanism may be a displacement pump driven by the actuator or a piezoelectric micropump. The liquid reservoir may be removable.

In another aspect of the invention, an exemplary cordless ultrasonic dental scaler includes a cordless ultrasonic dental scaler docking station featuring means for recharging the rechargeable power supply, such as conductive electrodes or an induction coil. The docking station also features means for supplying liquid to the liquid reservoir, such as a docking station pump and docking station reservoir fluidly coupled thereto.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high level section view that conceptually illustrates components of an exemplary cordless ultrasonic scaler in accordance with the principles of the invention; and

FIG. 2 provides a block diagram that conceptually illustrates components of an exemplary cordless ultrasonic scaler in accordance with the principles of the invention; and

FIG. 3 conceptually illustrates exemplary coaxial battery and fluid compartments in accordance with principles of the invention; and

FIG. 4 conceptually illustrates an exemplary docking station in accordance with principles of the invention.

The Figures are provided to conceptually illustrate exemplary embodiments in accordance with principles of the invention. However, the invention is not limited to those exemplary embodiments depicted in the Figures. Those skilled in the art will appreciate that Figures are not intended to be drawn to any particular scale; the invention is not limited to the dimensions or proportions shown in Figures; the invention is also not limited to the selection, arrangement and coordination of information, items, aesthetic elements, and components shown in the Figures; and the Figures are not intended to illustrate every embodiment of the invention.

### DETAILED DESCRIPTION

This invention provides a cordless ultrasonic dental scaler. The scaler contains an actuator, power supply, control circuitry, a water reservoir and a pumping mechanism within the hand piece.

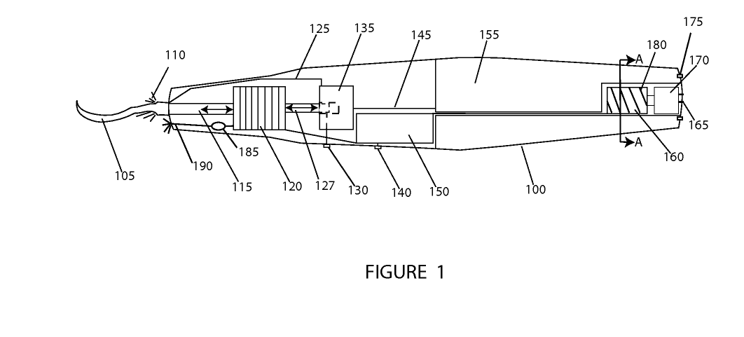

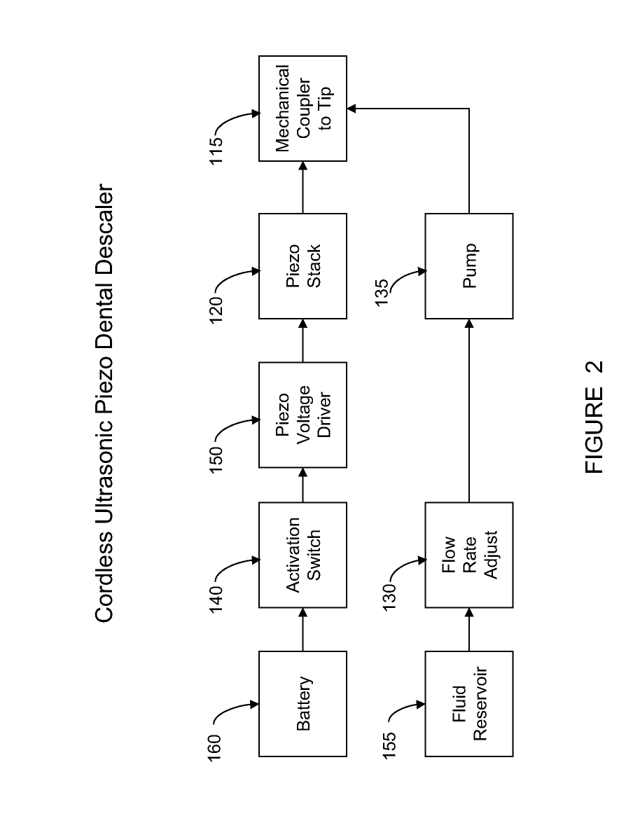

Referring to FIG. 1, a high level section view that conceptually illustrates components of an exemplary cordless ultrasonic dental scaler in accordance with the principles of the invention is provided. Similarly, FIG. 2 provides a block diagram that conceptually illustrates components of an exemplary cordless ultrasonic dental scaler in accordance with the principles of the invention. An actuator 120 is operably coupled via a mechanical linkage 115 to a cleaning tip 105. The actuator produces vibratory motion from applied electrical energy. Vibratory motion of the actuator 120 causes vibratory motion of the cleaning tip 105, which is operably coupled to the actuator by a linkage 115.

In an exemplary implementation, a piezoelectric actuator such as a piezoelectric stack is utilized as the actuator 120. A voltage applied to certain crystalline structures comprised of electro-active ceramic elements causes the crystal lattice to warp, thus producing mechanical displacement. This displacement is proportional to the applied voltage and the configuration of the elements. In general the higher the applied voltage, the greater the mechanical displacement. Oscillating the voltage displaces the elements to produce vibratory motion and forces. Depending upon the axis of stimulation, stacking several layers of piezoelectric elements (e.g., discs) may increase the total deformation, and thus the total stroke. Illustratively, axial strain of 2% of the stack's length and motion on the order of 100 microns at 20 to 40 kHz can be maintained.

However, the invention is not limited to piezoelectric actuators such as piezoelectric stacks. Instead, other actuators capable of producing ultrasonic reciprocating and/or vibrating motion using battery power within the confines of a cordless hand piece may be utilized in accordance with the scope of the invention. By way of example and not limitation, a motor, transducer or other electromagnetic actuator may be utilized within the scope of the invention.

The linkage 115 operably couples the actuator to the tip 105. The linkage 115 may comprise any force transmitting means coupled to the actuator at one end and adapted to engage the tip 105 at the other end. While the linkage 115 may be comprised essentially of a straight shaft, the invention is not limited to such a linkage or to producing linear motion of the tip 105 equal to displacement of the actuator 120. Non-linear motion, e.g., elliptical, circular and other patterns of motion, may be achieved by using correspondingly configured linkages 115. Additionally, the linkage 115 may be configured (e.g., with one or more levers and fulcrums) to impart some mechanical advantage or expand the range of motion of the actuator 120.

The cleaning tip 105 is releasably (e.g., threadedly) attached to the linkage 115. The tip 105 may be threaded and configured to screw on. It has a cavity for fluid to dispense and an o-ring to prevent leakage. The cleaning tip 105 is secured firmly to the linkage 115 during use. After use, the cleaning tip may be removed for sterilization, while the rest of the ultrasonic scaler may be cleaned with cleaning solutions.

As a result of the high rate of vibration the actuator generates significant heat. Optionally, to prevent overheating, the actuator may also be thermally coupled to a heat sink such as a copper or aluminum sleeve. One or more conduits 125 may be formed in the heat sink or may be placed adjacent to the heat sink to enable water from the reservoir 155 to act as a coolant and flow from the pump 135 through the conduit 125 to an outlet 110 at the tip 105. As a result heat may be dissipated in an efficient manner.

In an exemplary embodiment, the liquid expelled from the outlet 110 is atomized. Atomization will lower the expelled liquid's temperature due to the specific heat of vaporization, thus making it a more efficient cooling mechanism for the tooth being cleaned.

A control circuit 150 governs operation. The circuit includes a piezo voltage driver configured to convert electrical power from a power supply 160 to an (preferably the most) effective power waveform for the actuator. The proportional displacement-to-voltage characteristic of a piezoelectric actuator permits an open-loop mode of operation. Thus, the circuit 150 may include a microcontroller that supervises power conversion and monitors signals from the piezoelectric actuator 120. These signals could include a voltage feedback signal to optimize the voltage waveform, and one or more temperature signals. The temperature information may be used to limit or prevent damage to the instrument or patient tissue in case of overheating. The control circuit 150 may also be adapted to control a lead screw, micropump and light emitting lamp 180, which may optionally be utilized with the scaler.

An activation switch 140 controls start and stop of the ultrasonic device. The switch may be a simple means of interrupting current flow from the battery 160 to the control circuit 150, or it might supply a logic signal to the control circuit. The switch 150 is constructed and mounted so as to not permit liquids to enter the interior of the device, causing damage to the electronic components.

By way of example and not limitation, the switch 140 may comprise a rotary potentiometer operably coupled to the control circuit 150. The switch may be configured to provide off and on settings as well as a range of power levels. Power settings may be identified (e.g., numerically or graphically) on or adjacent to the switch.

An illumination mechanism 190 for illuminating the oral cavity may be provided for the scaler 100. A light emitting lamp 185 (e.g., an LED) may be mounted within the scaler. Light from the LED 185 may be transmitted by fiber optic means comprising an optically transmissive filament 190 to a point at or near the cleaning tip 105. The control circuit 150 may be adapted to energize the lamp 185 when the device is in use.

A pumping mechanism 135 is provided to draw and/or force liquid (e.g., water) from the reservoir 155 and supply the liquid to the tip 105. In an exemplary implementation, the pumping mechanism 135 dispenses fluid at a rate of about 14 ml during an approximately 5 min period of operation. This equates to a flow of about 2.8 ml/min. The pumping mechanism 135 may be a displacement pump (e.g., a diaphragm pump) driven via a pump linkage 127 coupling the pump 135 to the actuator 120. Thus, when the pump 135 is coupled to the actuator 120, the pump 135 will operate whenever the actuator 120 operates. Thus, actuation of the actuator 120 may drive both the tip 105 and the pumping mechanism 135. Using a flow rate adjustment 130 the pump linkage 127 can be coupled to or decoupled from the pump 135 (or actuator 120). When the pump linkage 127 is decoupled, activation of the actuator does not activate meaning that no fluid is pumped to the tip. One or more adjustable valves may be provided to regulate the flow of pumped fluid to the tip.

In an alternative embodiment, a piezo actuated micropump may be utilized for pumping the liquid. The micropump may be used in addition to or in lieu of the pump described above. Such micropumps generally include a fluid inlet, a fluid outlet, and a pumping chamber. The fluid inlet channel and the fluid outlet channel directly or indirectly communicate with the pumping chamber. The pumping chamber is formed between a diaphragm and a reservoir in the pump body. A piezoelectric strip actuator is attached to the diaphragm. By applying a voltage to the actuator, the actuator is deformed and the diaphragm is raised or lowered. Valves such as reed valves may be provided on the inlet and outlet. The valves open and close the inlet and outlet channels in response to raising and lowering the diaphragm.

A liquid reservoir 155 is provided to hold a liquid to be pumped out 110 at the tip 105. The reservoir has an outlet in fluid communication with the pumping mechanism 135 and may also have a separate inlet for filling. As discussed above, this liquid may serve as a coolant that conducts heat from certain components inside the device, and then as it is emitted and atomized, the patient's tooth. The liquid may be water, with or without additives such as antibacterial, descaling or therapeutic agents. The reservoir 155 may be a removable container or an integral part of the hand piece 100.

In one embodiment, the volume of the reservoir 155 is variable to accommodate different volumes of liquid and to eliminate the need to introduce air into the system. Examples of suitable variable-style reservoirs include syringe-type devices, bellows-type devices and bladder-type devices. A preferred variable volume device from a reliability standpoint in a multi-use environment is a syringe-type device having a movable plunger that can be controllably advanced and retracted inside a cylindrical tube. In such an embodiment, a lead screw controlled by the control circuit 150 may controllably push and pull the plunger of the syringe type reservoir to dispense the liquid and to refill the reservoir. This pumping mechanism may be utilized alone to supply liquid to the tip 105 or in conjunction with one or more of the other pumping mechanisms as described above.

A fluid pathway 125, 145 extends from the reservoir 155 to the pump 135, and from the pump 135 to the outlet 110 of the cleaning tip 105. The pathway may be comprised of sections of conduit, such as hoses, tubes and/or pipes. Each portion of the fluid pathway 125, 145 is preferably removable for sterilization and maintenance.

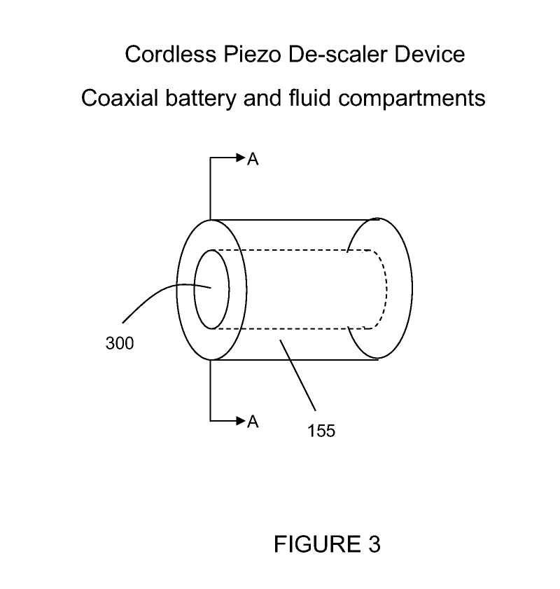

A power supply 160 such as one or more batteries is provided in a battery compartment 300, as shown in FIG. 3. To efficiently utilize available space and evenly distribute weight, the battery compartment may be surrounded by the reservoir 155. Disposable and/or rechargeable batteries may be utilized within the scope of the invention.

In an exemplary embodiment, a battery recharging circuit 170 is provided to manage recharging the battery 160. By way of example and not limitation, the battery recharging circuit may switch an externally supplied constant current on and off. The recharging circuit may include a microcontroller or other circuitry configured to sense voltage of the battery 160. When the recharging circuit 170 detects a peak in voltage that begins to drop, the battery 160 has been fully charged. The charge may then be switched to a trickle charge to maintain the battery in a charged state.

The battery may be recharged conductively through electrodes. Illustratively, a pair of recharging electrodes 165 extend from the recharging circuitry 170. When the ultrasonic scaler 100 is not in use, it may rest in a docking station with the electrodes 165 electrically contacting charging electrodes in the docking station.

Alternatively, the battery 160 may be inductively charged. Optionally, an induction charging coil 180 may be provided and electrically connected to the charging circuit. The battery 160 may be rechargeable by electromagnetic induction. Chargers which use inductive charging remove the need to have open electrical contacts hence allowing the adaptor and device to be sealed and used in wet environments. Electromagnetically coupling the coil 180 to a corresponding coil 415 in the docking station 400 enables recharging the battery 160 by induction.

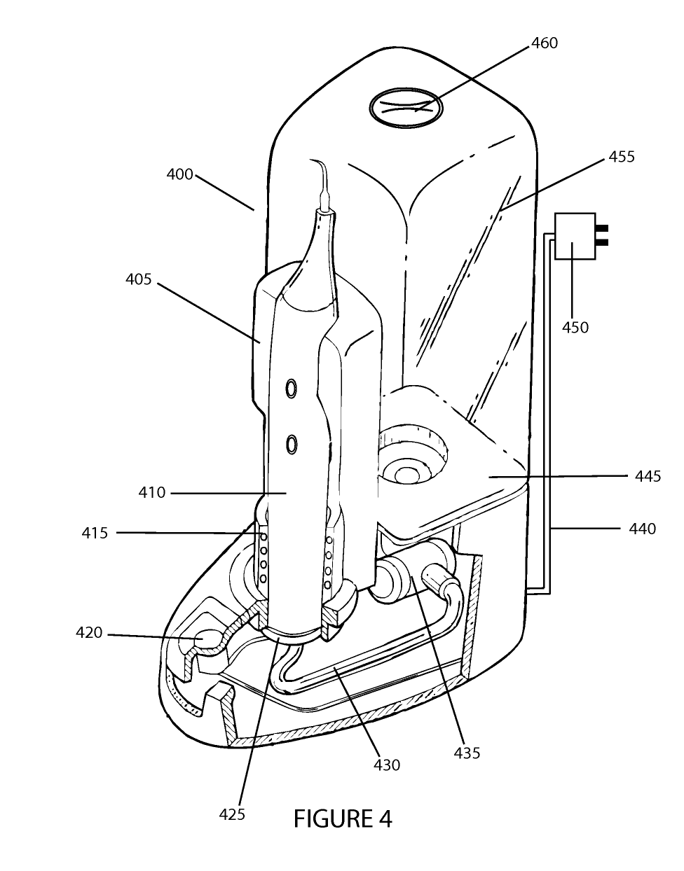

Referring now to FIG. 4, an exemplary embodiment of the scaler 100 is shown releasably mounted on a docking station 400 with a 405 fluid reservoir, a thermoelectric device 445 adapted for cooling the liquid in the reservoir, a pump 435 adapted to supply water from the reservoir to the scaler 100, and an electrical recharging system 415 adapted to recharge the rechargeable power supply of the scaler 100. The docking station 400 may utilize available utility power. A power transformer 450 is provided to convert utility power (e.g., 110 V A/C) to a current suitable for the recharging system. Electrical wires 440 couple the docking station's electrodes or induction coils 415 to the transformer 450.

Preferably, liquid supplied to the scaler is cool. Means for cooling the liquid in the reservoir 455 may include a thermoelectric cooler (TEC) in thermal communication with the liquid. To improve heat transfer between the cooling device and liquid, the liquid may be circulated in the reservoir 455. An exemplary TEC known as a Peltier effect heat pump is a solid-state active heat pump which transfers heat from one side of the device to the other. The Peltier effect heat pump comprises two dissimilar metals or semiconductors (n-type and p-type) that are connected to each other at two junctions (Peltier junctions). When a current is passed through the two dissimilar metals or semiconductors (n-type and p-type) the current drives a transfer of heat from one junction to the other, cooling off one junction while heating the other. A fan and/or heat sink may be provided to cool the heated side of the heat pump.

The docking station fluid reservoir contains a liquid (e.g., water) to replenish liquid in the reservoir of the scaler. A removable opening such as a threaded cap 410 provides access to the reservoir. The reservoir housing may be transparent or translucent to permit a user to visually inspect fluid contained therein. Liquid within the fluid reservoir is pumped from fluid reservoir chamber 102 using a pump 415, through a conduit 420, through a pressure limit cutoff switch, through a fluid coupling 425 and eventually into the scaler reservoir 155. The pressure limit cutoff switch may be a separate component or a part of the pump 435. The pump 435 should automatically cease pumping or be manually deactivated when the scaler reservoir 155 is full.

The docking station may include an actuation mechanism such as an on/off power switch 420. Alternatively, the docking station may be adapted to actuate upon detecting the presence of a docked scaler.

A handle assembly of the scaler 100 is mounted within a corresponding socket and/or docking clamp assembly 405 of the docking station. In this manner, the scaler 100 may be releasably secured by the docking station 400 when the scaler 100 is not in use. The docking station 405 includes a fluid coupling 425 for liquid to be transported from the docking station reservoir 455 into the scaler reservoir 155. When the scaler is placed and properly aligned in the docking station 400, the recharging electrodes 165 of the scaler 100 contact corresponding electrodes of the docking station, or, in the case of inductive charging, the recharging coil of the scaler 180 is in proximity to the recharging coil 415 of the docking station 400. Concomitantly, the fluid coupling 425 completes a fluid path for liquid to be transported from the docking station reservoir 455 into the scaler reservoir 155.

The distribution of mass in the device is important. The device may be substantially balanced, so that the center of mass is near the center of the device. Balance facilitates manipulation. Additionally, the total mass of the device influences the force exerted. Battery mass, a key component of the overall mass, adds to the inertia of the tool and thus controls how much vibrational force will be applied to the tooth at various frequencies of operation.

In a preferred embodiment, the device is roughly cylindrical and small enough and light enough to be easily held in an operator's hand. Various ergonomic contours and grips may be applied to increase gripping comfort.

While the invention has been described in terms of various embodiments, implementations and examples, those skilled in the art will recognize that the invention can be practiced with modification within the spirit and scope of the appended claims including equivalents thereof. The foregoing is considered as illustrative only of the principles of the invention. Variations and modifications may be affected within the scope and spirit of the invention.

What is claimed is:

1. A cordless ultrasonic dental scaler comprising
a scaler tip having a conduit for passage of a liquid, and
a hand piece, said hand piece containing
an actuator coupled to the scaler tip,
a linkage adapted for coupling the scaler tip to the actuator,
a portable rechargeable power supply,
control circuitry electrically connected to said power supply and to said actuator, said control circuitry being configured to energize said actuator,
a liquid reservoir, and
a pumping mechanism in fluid communication with said liquid reservoir and said scaler tip and adapted to pump liquid from the liquid reservoir to scaler tip.

2. A cordless ultrasonic dental scaler according to claim 1, said control circuit being configured to produce a voltage waveform and said actuator being configured to receive said voltage waveform and vibrate in response thereto, the linkage transmitting vibration of the actuator to the scaler tip.

3. A cordless ultrasonic dental scaler according to claim 2, said actuator being a piezoelectric actuator.

4. A cordless ultrasonic dental scaler according to claim 3, said piezoelectric actuator being a piezoelectric electric stack comprising a plurality of electro-active ceramic elements responsive to said voltage waveform.

5. A cordless ultrasonic dental scaler according to claim 1, said actuator including an electromagnetic driver from the group consisting of a piezoelectric actuator, a motor and a transducer.

6. A cordless ultrasonic dental scaler according to claim 1, said linkage comprising a force transmitting means having a first end and a second end and being coupled to the actuator at the first end and adapted to engage the scaler tip at the second end.

7. A cordless ultrasonic dental scaler according to claim 1, said cleaning tip being releasably attached to the linkage.

8. A cordless ultrasonic dental scaler according to claim 7, said cleaning tip being threadedly attached to the linkage.

9. A cordless ultrasonic dental scaler according to claim 1, further comprising a heat sink, said actuator being thermally coupled to the heat sink.

10. A cordless ultrasonic dental scaler according to claim 1, further comprising a heat sink, said actuator being thermally coupled to the heat sink, said heat sink including a liquid conduit in fluid communication between the liquid reservoir and scaler tip, said conduit enabling liquid from the reservoir to flow through the conduit and cool the actuator.

11. A cordless ultrasonic dental scaler according to claim 1, said conduit for passage of a liquid terminating with an atomizing nozzle, said atomizing nozzle being configured to atomize liquid expelled therefrom.

12. A cordless ultrasonic dental scaler according to claim 1, said control circuitry including a piezo voltage driver adapted to controllably energize the actuator, said actuator being a piezoelectric actuator.

13. A cordless ultrasonic dental scaler according to claim 12, said piezoelectric actuator being adapted to generate feedback signals and said control circuitry further including a microcontroller adapted to receive and monitor feedback signals from the piezoelectric actuator to adjust the voltage waveform.

14. A cordless ultrasonic dental scaler according to claim 12, said piezoelectric actuator being adapted to generate feedback signals including a temperature signal corresponding to the actuator, and said control circuitry further including a microcontroller adapted to receive and monitor feedback signals from the piezoelectric actuator to adjust the voltage waveform

15. A cordless ultrasonic dental scaler according to claim 1, further comprising a light source adapted to illuminate the scaler tip.

16. A cordless ultrasonic dental scaler according to claim 1, further comprising a light source adapted to illuminate the scaler tip, said light source comprising an LED within the handle and a fiber optic filament configured to transmit light from the LED to the scaler tip.

17. A cordless ultrasonic dental scaler according to claim 1, said pumping mechanism comprising a displacement pump driven by said actuator.

18. A cordless ultrasonic dental scaler according to claim 1, said pumping mechanism comprising a piezoelectric micropump.

19. A cordless ultrasonic dental scaler according to claim 1, said liquid reservoir being removable.

20. A cordless ultrasonic dental scaler system comprising
a cordless ultrasonic dental scaler comprising
a scaler tip having a conduit for passage of a liquid, and
a hand piece, said hand piece containing
an actuator coupled to the scaler tip,
a linkage adapted for coupling the scaler tip to the actuator,
a rechargeable power supply,
control circuitry electrically connected to said power supply and to said actuator, said control circuitry being configured to energize said actuator,
a liquid reservoir, and
a pumping mechanism in fluid communication with said liquid reservoir and said scaler tip and adapted to pump liquid from the liquid reservoir to scaler tip; and
a cordless ultrasonic dental scaler docking station adapted to mechanically support the cordless ultrasonic dental scaler and comprising
means for recharging the rechargeable power supply, said means comprising recharger components from the group consisting of conductive electrodes and an induction coil, and
means for supplying liquid to the liquid reservoir, including a docking station reservoir and docking station pump adapted to fluidly engage the scaler reservoir.
